(19) United States
(12) Patent Application Publication
(10) Pub. No.: US 2005/0263940 A1
(43) Pub. Date: Dec. 1, 2005

(54) Method for the production of self-cleaning films in a blow molding method

(76) Inventors: Martin Backmann, Lengerich (DE); Klemens Sensen, Lengerich (DE)

Correspondence Address: JACOBSON HOLMAN PLLC, 400 SEVENTH STREET N.W., SUITE 600, WASHINGTON, DC, 20004, US

(21) Appl. No.: 10/524,502

(22) PCT Filed: Aug. 21, 2003
(86) PCT No.: PCT/EP03/09283

§ 371 Date: Feb. 14, 2005

(30) Foreign Application Priority Data
Sep. 10, 2002 (DE) 10242174.9

(51) Int. Cl. B29C 47/00

(52) U.S. Cl. 264/210.2; 264/288.4

(57) ABSTRACT

A process is described for manufacturing blown film tubes (3) that are equipped with at least one self-cleaning surface that contains the following characteristics of the process:
Formation of a plastic melt in an extruder (2) Compression of the plastic melt in a blowing head that has a ring-shaped output gap.
Extrusion of a film tube (3) from this ring-shaped gap
Expansion of the radius (R1) of the film tube (3) by creating a corresponding pressure inside the film tube (3) by the blow factor (FR)
Squeezing the film tube (3) with nip rollers (4)
Stretching the film tube (3) in its axial direction (z) by the length stretch factor (FZ).

The inventiveness lies in the fact that at least one surface of the film tube (3) is provided with elevations in that the material required for the formation of the elevations is either added before the extrusion of the plastic melt from the ring-shaped gap or is spread on at least one surface of the film tube (3) after the extrusion.

The invention concerns a process for manufacturing blown film tubes that are equipped with at least one self-cleaning surface.

Processes for the manufacture of blown film tubes are generally known. In such processes first a plastic melt is formed in an extruder. This melt is compressed subsequently in a blowing head that has a ring-shaped output gap. In the subsequent step of the process the film tube is extruded from this ring-shaped gap and thereafter expanded by producing a corresponding pressure inside the tube that is higher than the external pressure by a blow factor. Subsequently the film tube runs through a squeezing device. In doing so the film tube is stretched in its axial direction by one length stretch factor.

In order to equip such a film tube with a self-cleaning surface further process steps are necessary. The effect of a self-cleaning surface arises if a hydrophobic surface has elevations and depressions. These elevations must thereby maintain definite distances that may neither be exceeded nor fallen short of. Thus the patent specification EP 0 772 514 B1 describes a process for manufacturing self-cleaning surfaces of objects whereby a surface structure out of hydrophobic material is created by stamping, etching or adhesive bonding of a powder.

However, the subsequent handling of the film tube is very expensive.

Therefore the task underlying the present invention is to suggest a process that equips the film tube already in the extrusion process with at least one self-cleaning surface.

The task is solved by the fact that the at least one surface is provided with elevations in that the material required for forming the elevations is added either before the extrusion of the plastic melt out of the ring-shaped gap or is spread over the surface directly after the extrusion.

It is advantageous if the material required for the production of the elevations is a component of another melt.

It is also advantageous to use particulates for forming the elevations.

In a preferential design form of the invention the use of nanoparticulates is intended.

By the subsequent expansion and stretching of the film tube the distances between the elevations in axial and/or radial direction can be exceeded. In accordance with a particularly preferential design form of the invention the ratio between the blow factor and the length stretch factor is larger than 1/4.

In another preferential design form the ratio between the blow factor and length stretch factor is larger than 1/3.

Advantageously a ratio between the blow factor and the length stretch factor is selected to be larger than 1/2.

The selection of a ratio of more than 2/3 between the blow factor and length stretch factor is particularly advantageous.

In a preferential design form of the invention the relation between the blow factor and the length stretch factor is larger than 10/11.

In another preferential design form of the invention includes a relation between the blow factor and the length stretch factor of 1/1.

Examples of implementation of the invention are based on the graphic description and the claims.

The individual figures illustrate:

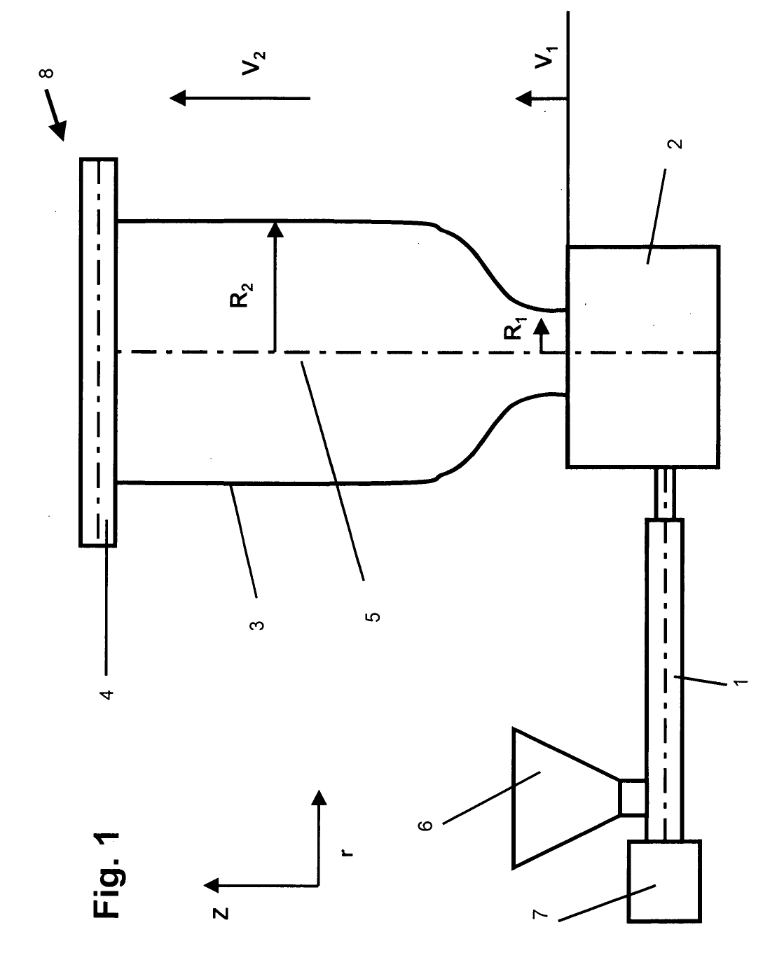

FIG. 1 Side view of a device for manufacturing a film tube.

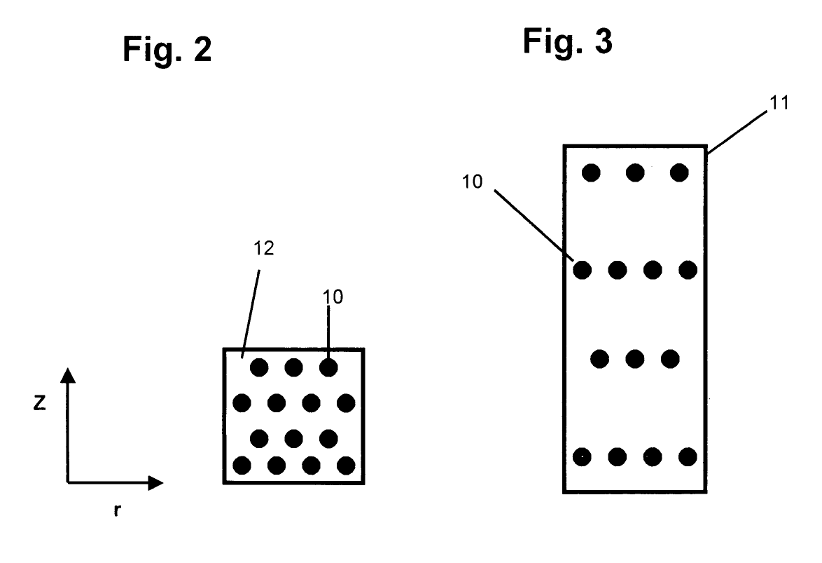

FIG. 2 Cutout from an unstretched film tube

FIG. 3 Cutout from a film tube that is stretched in z-direction.

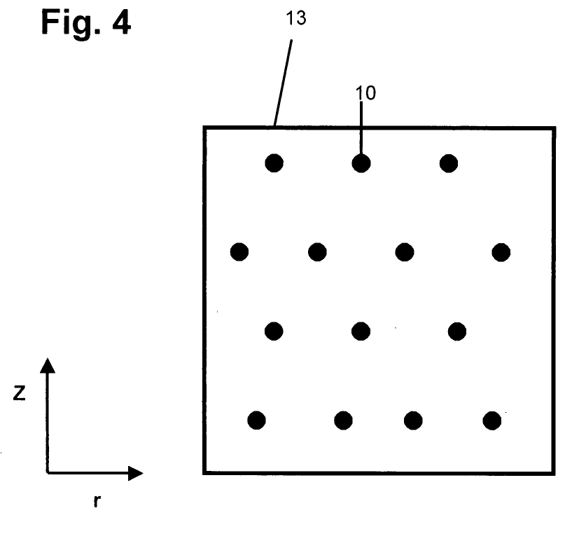

FIG. 4 Cutout from a film tube that is stretched in r and z directions.

FIG. 1 illustrates a device for implementing the process for manufacturing a blown film tube with at least one self-cleaning surface. The film blowing head 2 is fed with the material to be extruded via a conveying screw 1. The material to be extruded is filled in via a funnel tube 6. The conveying screw 1 is driven by a motor 7. The material is molten in the film blowing head 2 in a manner that is not illustrated more elaborately and is compressed in an annular gap. The film tube 3 is extruded from this annular gap. In doing so the film tube 3 has a radius R₁ that is essentially identical to the radius of the annular gap. The extrusion speed is identified by V₁. By the production of an internal pressure (not illustrated more elaborately) the blown film 3 is in the further course of the procedure expanded to a radius R₂ whereby the imaginary centerline 5 of the film tube 3 is maintained. The ratio of the radius R₂ to the radius R₁ is identified as blow factor FR. To prevent the air ensuring the internal pressure from escaping, the film tube 3 runs through a squeezing device 5 that consists of two nip (squeegee) rollers between which the film runs. From this set of nip rollers only the front nip roller 4 is visible. The peripheral (circumferential) speed of the nip rollers V₂ can however be selected to be different than the extrusion speed V₁. This results in the stretching of the film tube (V₂>V₁). Immediately before the arrival of the film tube 3 in the squeezing device 5 the conveying speed of the film tube also amounts to V₂. The ratio of the circumferential speed of the nip rollers V₂ to the extrusion speed V₁ is indicated as length stretch factor FZ.

The length stretch factor FZ is set entirely by the selection of the circumferential speed of the nip rollers. The blow factor is set by the selection of the internal pressure.

The setting of the length stretch factor FZ and/or the blow factor FR influences the distance of the nanoparticulates in radial direction r and/or in axial direction z. In FIG. 2 a cutout of an unstretched film tube 12 can be seen. The distances of the particulates 10 forming the elevations are constant both in direction r and also in direction z.

In FIG. 3 the length stretch factor FZ is set to be larger than the blow factor FR so that the distance of the particulates 10 in z direction is larger than in r direction. The result is a film section 11 that is stretched more strongly in axial direction.

In FIG. 4 an evenly stretched film section 13 is displayed, for the formation of which, the length stretch factor FZ and the blow factor FR P were selected to be equally large. The distances of the particulates 10 are equally large in direction r and in direction z and clearly larger as opposed to the unstretched film tube illustrated in FIG. 2.

List of reference symbols

| | |
|---|---|
| 1 | Conveying screw |
| 2 | Film blowing head |
| 3 | Film tube |
| 4 | Nip roller |
| 5 | Symmetry axis of the film tube |
| 6 | Funnel tube |
| 7 | Motor |
| 8 | Squeezing device |
| 9 | |
| 10 | Particulates/Nanoparticulates |
| 11 | Film tube that is more strongly stretched in axial direction |
| 12 | Unstretched film section |
| 13 | Evenly stretched film section |
| 14 | |
| 15 | |
| 16 | |
| 17 | |
| 18 | |
| 19 | |
| 20 | |
| 21 | |
| 22 | |
| 23 | |
| 24 | |

1. Process for manufacturing blown film tubes (3) that are equipped with at least one self cleaning surface that includes the following characteristics of the process:
Formation of a plastic melt in an extruder (2)
Compression of the plastic melt in a blowing head that has a ring-shaped output gap.
Extrusion of a film tube (3) from this ring-shaped gap
Expansion of the radius (R1) of the film tube (3) by creating a corresponding pressure inside the film tube (3) by the blow factor (FR)
Squeezing the film tube (3) with nip rollers (4)
Stretching the film tube (3) in its axial direction (z) by the length stretch factor (FZ)
characterized by the fact that,
at least one surface of the film tube (3) is provided with elevations in that the material required for the formation of the elevations is added either before the extrusion of the plastic melt from the ring-shaped gap or is spread on at least one surface of the film tube (3) after the extrusion.

2. Process in accordance with claim 1 characterized by the fact that the matter volumes required for the formation of elevations are a component of another melt.

3. Process in accordance with claim 1 characterized by the fact that particulates (10) are used for the formation of elevations.

4. Process in accordance with claim 3 characterized by the fact that the particulates (10) are nanoparticulates.

5. Process in accordance with claim 1 characterized by the fact that the ratio between the blow factor (FR) and the length stretch factor (FZ) is larger than 1/4.

6. Process in accordance with claim 5 characterized by the fact that the ratio between the blow factor (FR) and the length stretch factor (FZ) is larger than 1/3.

7. Process in accordance with claim 6 characterized by the fact that the ratio between the blow factor (FR) and the length stretch factor (FZ) is larger than 1/2.

8. Process in accordance with claim 7 characterized by the fact that the ratio between the blow factor (FR) and the length stretch factor (FZ) is larger than 2/3.

9. Process in accordance with claim 8 characterized by the fact that the ratio between the blow factor (FR) and the length stretch factor (FZ) is larger than 10/11.

10. Process in accordance with claim 9 characterized by the fact that the ratio between the blow factor (FR) and the length stretch factor (FZ) is larger than 1/1.

11. Process in accordance with claim 2 characterized by the fact that the ratio between the blow factor (FR) and the length stretch factor (FZ) is larger than 1/4.

12. Process in accordance with claim 3 characterized by the fact that the ratio between the blow factor (FR) and the length stretch factor (FZ) is larger than 1/4.

13. Process in accordance with claim 4 characterized by the fact that the ratio between the blow factor (FR) and the length stretch factor (FZ) is larger than 1/4.
